(19) United States
(12) Patent Application Publication
(10) Pub. No.: US 2026/0180896 A1
(43) Pub. Date: Jun. 25, 2026

(54) TRAFFIC-BASED ROLE ELECTION USING DISTRIBUTED LOCKS

(71) Applicant: Palo Alto Networks, Inc., Santa Clara, CA (US)

(72) Inventors: Mandar Balkrishna Amle, Fremont, CA (US); Ketan Kulkarni, San Jose, CA (US)

(21) Appl. No.: 18/988,513

(22) Filed: Dec. 19, 2024

(51) Int. Cl. H04L 9/40

(52) U.S. Cl. CPC H04L 63/0227

(57) ABSTRACT

Various techniques for traffic-based role election using distributed locks are disclosed. In some embodiments, a system, process, and/or computer program product for traffic-based role election using distributed locks includes receiving network traffic from a plurality of branches at a network load balancer (NLB) of a cluster of a cloud security service (CSS), wherein the cluster includes a plurality of network processing nodes (NPNs); and selecting an active NPN from the plurality of NPNs using a high-availability asynchronous role election and distributed locks mechanism; and sending the network traffic from the NLB to the active NPN.

### BACKGROUND OF THE INVENTION

Cloud infrastructures with network load balancers are often deployed with two or more intermediate network nodes. When an intermediate network node fails a variety of complications may arise such as network tunnels flapping or impacts on an existing user session. Complex, stateful, and high traffic applications/services require highly synchronous behavior to avoid network latency and function properly.

### BRIEF DESCRIPTION OF THE DRAWINGS

Various embodiments of the invention are disclosed in the following detailed description and the accompanying drawings.

FIG. 1A is a system diagram for routing network traffic from one or more branches where the primary NPN is healthy in accordance with some embodiments.

FIG. 1B is a system diagram for routing network traffic from one or more branches where the primary NPN is unhealthy in accordance with some embodiments.

FIG. 2 is a system diagram of a CSS cluster in accordance with some embodiments.

FIG. 3 is a process diagram of a process to route network traffic in accordance with some embodiments.

FIG. 4 is a process diagram of a process for determining an NPN to send network traffic to in accordance with some embodiments.

FIG. 5 is a process diagram of a process that an NPN executes on an interval in accordance with some embodiments.

FIG. 6 is a process diagram of a process that an NPN executes upon booting up in accordance with some embodiments.

FIG. 7 is a process diagram of a process that an NPN executes on an interval in accordance with some embodiments.

FIG. 8 is a process diagram of a process that an NPN executes on an interval in accordance with some embodiments.

FIG. 9 is a timeline illustrating a device failure within a CSS cluster in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A set of branches forward network traffic to a load balancer. The load balancer is part of a cloud security service (CSS) cluster. The cluster comprises a plurality of network processing nodes (NPNs). The load balancer sends network traffic to the one active NPN. Which NPN is active at any given time is determined by a high-availability asynchronous role election mechanism.

Networking information often requires that network traffic is securely forwarded to multiple sources to be routed to multiple destinations. Cloud-based applications rely on load balancers to route multiple branches of network traffic to one or more endpoints of the application. Users of high availability cloud-based applications expect that their connections are seamless and reliable. Additionally, users and cloud-based applications require that their network traffic is securely routed. A CSS provides cloud-based applications with the infrastructure to facilitate the secure connections to highly available cloud-based applications from multiple users.

In addition to load balancers, CSS clusters may comprise a plurality of network nodes that receive network traffic from the load balancer. The plurality of nodes may exist to receive traffic from certain zones, or they may exist for redundancy in the case of a node failure. When a node failure occurs, a user's connection to a downstream destination may be negatively impacted, e.g., by a lost connection, lost data, tunnel flaps, lagging connection, etc.

Users and applications expect that their associated network traffic is secure from malicious activity. A CSS often employs IPsec (Internet Protocol Security) protocol to ensure that network traffic is routed securely. IPsec is crucial to ensuring the secure routing of network traffic, but its application may exacerbate negative effects on a user in the case of a node (e.g., NPN) failure. This is because a secure implementation of IPsec protocol implies that a current active node has exclusive access to critical resources such as databases, routing sessions, etc. Therefore, when a current active node fails, exclusive access to the critical resources must be transferred to the backup node.

Current solutions attempt to mitigate the negative effects of node failure by implementing methods to route network traffic through a second node when a first node fails. However, these current solutions still result in negative impacts on the user's connection. For example, the switch between a first node to a second node is noticeable to the end user. Current solutions also fail to aptly handle the requirements of IPsec after a node failure. These problems have an outsized effect on high availability applications, where seamless connectivity for users is mission critical.

The techniques disclosed herein allow for the seamless handling of NPN failure. A high-availability asynchronous role election mechanism that comprises two locks, the active lock and the traffic lock, is employed in a CSS cluster with two or more NPNs. A network load balancer (NLB) is configured to send network traffic from a plurality of branches through a single active NPN node at any given point in time. In some embodiments, there are two or more NPNs, a primary NPN and one or more secondary NPNs. If the CSS boots and the primary and one or more secondary NPNs are healthy, the primary node holds both the active lock (AL) and the traffic lock (TL). When the primary node is active, it also has exclusive access to the data necessary to implement IPsec on the incoming network traffic from the one or more branches. When an NPN holds the AL, it is granted exclusive access to the necessary IPsec data.

As the primary NPN is actively receiving network traffic from the NLB, the secondary NPN is concurrently performing a process that facilitates the rapid transfer of the active lock. In some embodiments, when the primary NPN fails, the NLB immediately begins sending traffic to the secondary NPN.

Suppose the primary NPN has failed. Every set interval, (e.g., 1 millisecond (ms), 1 second, 2 seconds, etc.) the secondary NPN determines if it is receiving network traffic. Upon a determination that it is receiving network traffic (e.g., from the NLB because the primary NPN has failed), the secondary NPN successfully retrieves the traffic lock.

An NPN is configured such that it periodically attempts to retrieve the traffic lock and drop the traffic lock when it is receiving traffic. The NPN is successful in retrieving the traffic lock when it is receiving traffic. Even while the NPN is receiving traffic it drops and attempts to retrieve the traffic lock.

Referring back to the example, after the secondary NPN acquires the TL, it determines whether its current role is standby or active. Upon a determination that its current role is standby, it attempts to acquire the active lock. Upon a determination that has successfully retrieved the active lock, it switches its role to active. At this point, the secondary NPN has seamlessly recovered the traffic and the active role after the primary NPN's failure.

An NPN is configured such that it applies a time to live (TTL) scheme to the active lock. The TTL scheme of the active lock causes the active lock to automatically renew as long as the NPN is healthy. When the NPN becomes unhealthy, the active lock is not renewed, and a different NPN is able to acquire the active lock.

The NPN with the active lock is granted exclusive access to any information that may facilitate the transfer of network traffic, such as information that allows it to facilitate IPsec protocol for the network traffic received from the NLB and originating from the branches.

The techniques disclosed herein allow for seamless and secure network traffic routing despite the failure of an NPN. The high-availability asynchronous role election mechanism ensures that an NPN will always be prepared to receive traffic and route the traffic to a next destination. The transition from a node that has failed to a currently active node is enabled even with the use of IPsec protocol, thus ensuring the security of the network traffic.

The techniques disclosed herein are superior to traditional role election algorithms and introduce less complexity thus leading to a more error free CSS. The techniques disclosed herein allow a switch between an active NPN to a backup NPN without a noticeable difference to users. One unique advantage arises from the use of the TTL scheme for the active lock. The TTL scheme means that the active lock will be auto released if not renewed for a given duration. This means that when an NPN dies it cannot renew the lock. Thus, upon the failure of an NPN, the active lock will be acquired by the standby NPN node. This configuration ensures that there will always be one instance holding the active lock.

The techniques disclosed herein provide a unique advantage of preemption. The traffic lock has the property of preemption because the NPN that holds the traffic lock must continuously release and attempt to retrieve the traffic lock. The currently inactive NPN that is not receiving the traffic is only able to retrieve the traffic lock because the currently active NPN is continuously releasing and acquiring the lock.

The techniques disclosed herein are asynchronous, which eliminates the need for complex communication protocols between the two nodes. Current solutions do not guarantee mutual exclusion, while the techniques disclosed herein provide leader election and mutual exclusion.

The techniques disclosed herein can be implemented on many standard and legacy cloud environments because it is strongly consistent with many common systems such as GCS™, Raft™, S3™, ETCD™, and many more.

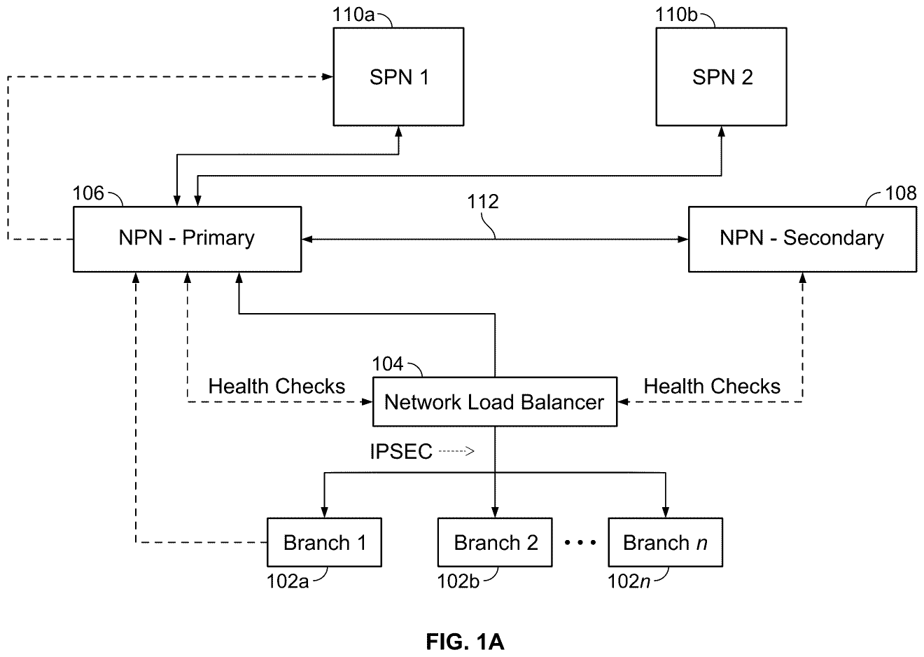

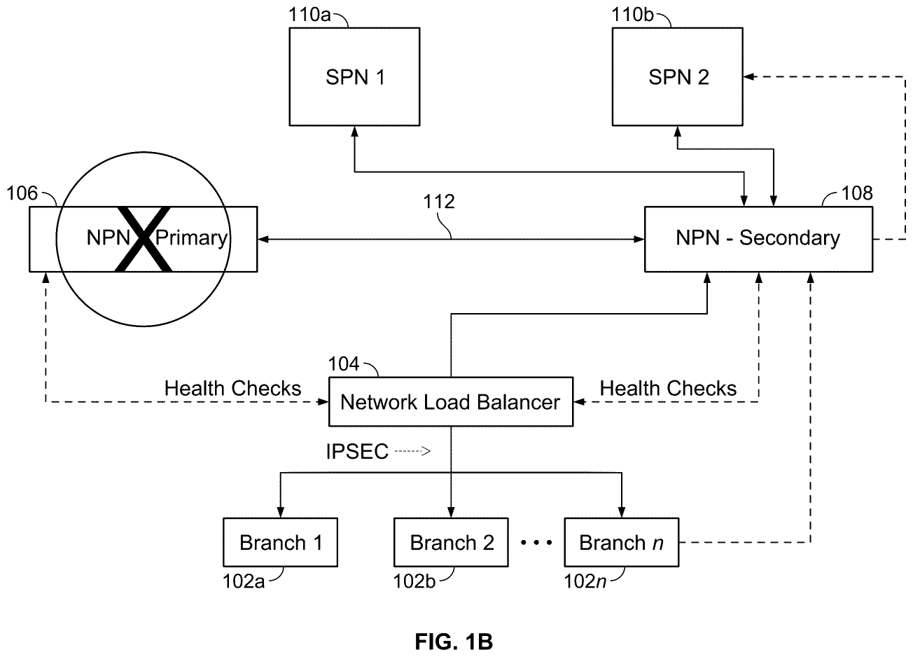

FIG. 1A is a system diagram for routing network traffic from one or more branches where the primary NPN is healthy in accordance with some embodiments. Branches 102a, 102b, 102n are streams of network traffic directed towards security processing nodes (SPNs) SPN 1 and/or SPN 2 110a and 110b. In this example, there are only two SPNs 110a and 110b, however this is merely for illustrative purposes as there can be one or a plurality of SPNs. In some embodiments, SPNs 110 facilitate sending network traffic to a public network such as the internet. SPNs 110a and 110b are a part of a CSS cluster further comprising network load balancer (NLB) 104, NPN—primary 106, and NPN—secondary 108.

In the example shown, dashed lines represent network routing configuration traffic and solid lines represent data traffic. Network routing configuration data may comprise any information relevant to routing network traffic from branches 102a, 102b, . . . 102n such as health checks, IPSec metadata, Network Address Translation (NAT) related data, etc.

Branches 102a, 102b, . . . 102n may represent sources of network traffic. In some embodiments, branch 102n is one or more users attempting to connect to a destination beyond SPNs 110 through the CSS cluster (e.g., a highly available cloud-based application). The CSS cluster may be a component of the user's cloud service provider package. For example, a user may be a part of an entity (e.g., an employee at a company, government, organization, etc.) where the entity has configured its network with a cloud service provider's CSS. To illustrate further, a user may be connecting to the internet through a device (e.g., computer, smartphone, smart-device, etc.) owned by the entity. The entity may require that any connection on the entity owned device is secure. In some embodiments, branches 102a, 102b, . . . 102n are office locations affiliated with an entity and comprise one or more users sending network traffic.

In some embodiments, branches 102a, 102b, . . . 102n send network traffic to NLB 104 such that it conforms with IPsec protocol. IPsec protocol may be used to establish a secure network tunnel for the network traffic from branches 102a, 102b, . . . 102n, through NLB 104, through NPN primary 106 or secondary 108, and to SPNs 110a and 110b. A secure network tunnel is used to prevent a malicious party from accessing or manipulating the network traffic. To establish the secure tunnels, IPsec protocol may encrypt network traffic at its source (i.e., branch 102n) and unencrypt it at its destination (e.g., SPN 110n). IPsec protocol may also authenticate the network traffic at its destination. To implement encryption/authentication in accordance with IPsec protocol, network routing configuration data may be sent from the source to the destination (e.g., authentication key and/or encryption methods). In this example, network routing configuration data is sent from branch 102n directly to NPN—primary 106, which forwards the network routing configuration to SPN 110n. The transmission of the network routing configuration data is illustrated through the use of dashed lines.

In some embodiments, network routing configuration data is sent using a secure protocol such as Interior Border Gateway Protocol (IBGP) and/or Exterior Border Gateway Protocol (eBGP). In some embodiments, the network routing configuration data from branches 102a, 102b, . . . 102n utilizes IBGP while the network routing configuration data from NPN—primary 106 utilizes EBGP. Any secure protocol may be utilized to facilitate the transmission of information over the BGP connections.

Network routing configuration data may comprise any information relevant to routing network traffic from branches 102a, 102b, . . . 102n such as health checks, IPSec metadata, Network Address Translation (NAT) related data, etc.

In some embodiments, BGP connections between branches 102a, 102b, . . . 102n through an NPN—primary 106 or secondary 108 and to an SPN 110a or 110b are necessary to implement IPsec protocol on a CSS cluster.

Network Load Balancer (NLB) 104 may be any device that can receive and send network traffic. In some embodiments, NLB 104 is the first device to receive network traffic that is sent to the CSS cluster. NLB 104 receives network traffic directed at the CSS cluster and may ensure that the load of network traffic on downstream devices is balanced, such that a downstream device is not overwhelmed.

In some embodiments, NLB 104 is configured to periodically determine the health of downstream NPNs (primary 106 or secondary 108) at any given time. In some embodiments, NLB 104 periodically sends health checks to one or more downstream NPNs. In response, NPNs are configured to forward information concerning the health of the instance. Health information may include a variety of information associated with the NPN's ability to perform its function, such as the state of a critical process, the CPU state, etc. In the example shown, connections that facilitate health checks are illustrated by the dashed lines from NLB 104 to NPN—primary 106 and NPN—secondary 108. In some embodiments, NLB 104 is configured to periodically send health checks to all downstream NPN's at an interval (e.g., every 1 sec).

In some embodiments, upon failing to receive a health check response or failing to receive a satisfactory health check response, NLB 104 determines that the corresponding NPN has failed. In some embodiments, upon a determination that an NPN has failed, NLB 104 immediately begins to forward traffic to a different NPN (e.g., NPN—primary 106 goes down, it fails to send a response health check, so NLB 104 immediately begins forwarding data to NPN—secondary 108).

NPN—primary 106 may be any device that is able to send and receive network traffic. For example, NPN—primary 106 may be a Virtual Machine (VM) running in the cloud. In some embodiments, when the CSS cluster boots, NPN—primary 106 is initially sent network traffic from NLB 104. In some embodiments, NPN—primary 106 boots and immediately acquires the active lock. The traffic lock may also be immediately acquired. The traffic lock is acquired by an NPN when it is receiving traffic. Therefore, the traffic lock may be initially acquired by NPN—primary 106 because NLB 104 initially sends network traffic to NPN—primary 106. In the example shown, NPN—primary 106 is healthy and is receiving network traffic data from NLB 104.

In some embodiments, NPN—primary 106 receives and sends network routing configuration data over BGP connections to one or more downstream components (e.g., SPN1 110a). In some embodiments, NPN—primary 106 establishes state sync communication 112 with NPN—secondary 108 to perform information exchange. State sync communication 112 may be used to sync IPsec information, such that when NPN—primary 106 becomes nonfunctional, NPN—secondary 108 may be able to reestablish an IPsec tunnel.

In some embodiments, state sync communication 112 enables BGP sessions to never go down upon the failure of an NPN. This is because the routing state is synchronized prior to the failure of an NPN. Routing state may include active routing paths, destination networks, etc. In some embodiments, the switchover is so quick that the BGP initiator does not have to re-advertise the routes. In some embodiments, after NPN—primary 106 fails, it stops responding to path monitoring probes from an SPN 110, thus ensuring that the SPN to NPN traffic is diverted to the new active NPN (e.g., NPN—secondary 108).

NPN—secondary 108 may be any device that is able to send and receive network traffic. In some embodiments, when the CSS cluster boots, NPN—secondary 108 is initially a standby/backup NPN. In some embodiments, NPN—secondary 108 is continuously executing a process to ensure that the switchover from NPN—primary 106 is seamless. In some embodiments, NPN—secondary 108 continuously checks to see if it is receiving traffic from NLB 104. NPN-secondary 108 may also be continuously ensuring that connection states are in sync through state sync communication 112. NPN—secondary 108 may also be continuously responding to health checks from NLB 104.

NPNs may be sending network traffic and network routing configuration data to one or more SPNs at any given time.

In some embodiments, NPNs perform NAT on network traffic before sending the traffic to an SPN. In some embodiments, NAT is performed when the network traffic is directed to a public network (e.g., the internet) such that the return traffic is sent to the public IP of an intermediate device (e.g., the NPN). NAT entries are tracked by the intermediate device to allow for the routing of the return traffic to the originator.

In some embodiments, NPNs primary 106 and secondary 108 learns the routing prefixes of every branch over eBGP. In some embodiments, NPNs 106 and 108 maintain IPsec tunnel state, NAT/connection tracking state, as well as routing state.

It should be understood that an NPN that is called the primary NPN merely indicates that it is the NPN that is sent network traffic when the CSS cluster initially boots. NPN—primary 106 and NPN—secondary 108 can be implemented as devices with identical and/or similar hardware and software implementations.

Security processing nodes (SPNs) 110a and 110b are any devices capable of receiving and forwarding network traffic. In some embodiments, SPN 110n is a VM instance with firewall functionality which is based on a tenant security policy configuration. In some embodiments, SPN 110n is a container-based instance of firewall functionality based on a tenant security policy configuration. In some embodiments, SPNs 110n determine the destination of network traffic received from an NPN. Network traffic may be sent to a public network (e.g., the internet), a private network (e.g., an entities cloud), an entities datacenter, between one or more branches 102a, 102b, . . . 102n, etc. The entity that owns the private network and/or the datacenter may be the same entity that owns the CSS cluster.

SPNs 110n may use network routing configuration data received over a BGP connection to facilitate the proper routing of network traffic. In some embodiments, SPNs 110n determine the routing of the network traffic using IP prefixes forwarded over BGP protocols. SPN 110n may perform any process that facilitates the secure routing of network traffic data, such as implementing IPsec protocol. In some embodiments, SPN 110n authenticates and decrypts network traffic using information received from BGP connections (e.g., authentication key, decryption key, etc.). SPN 110a or 110b is able to receive BGP traffic.

### Difference Between Active and Standby NPN

In some embodiments, a CSS cluster comprises an active NPN and a standby NPN at any given time. The active NPN holds the AL. In some embodiments, the active NPN is the single NPN that fulfills the responsibilities of the active role.

Responsibilities of the active role may comprise the ability to execute various processes. For example, the active NPN may send and receive IPsec data. Other examples include publishing High Availability (HA) sync messages, owning BGP sessions, acting as the healthy node from the perspective of SPN 110n (e.g., by receiving return traffic from SPN 110n), tracking entries for NAT, executing various application operations and processing, etc.

In some embodiments, an NPN is healthy when it is able to execute certain processes. The certain processes may include examples described in the previous paragraph. Additionally, an NPN may be considered healthy when it is able to perform basic functions such as receiving and sending network traffic.

There may be varying degrees of health such that an NPN is capable of executing certain functions but not others. In such cases, the NPN may be configured to release the active lock and become a standby. For example, suppose the NPN is able to send and receive network traffic but lacks the ability to own a BGP session. In this example, the NPN may be configured to release the active lock

FIG. 1B is a system diagram for routing network traffic from one or more branches where the primary NPN is unhealthy in accordance with some embodiments. In some embodiments, NLB 104 determines that NPN—primary 106 is unhealthy after sending a health probe and receiving an unsatisfactory response or not receiving a response at all. NLB 104 may have failed to receive a response where the NPN—primary 106 has completely crashed. In some embodiments, upon determining that NPN—primary 106 is unhealthy, NLB 104 immediately begins forwarding traffic to NPN—secondary 108.

In some embodiments, upon the determination that NPN—primary 106 is unhealthy, NPN—secondary 108 immediately reestablishes the BGP session, such that network routing configuration data (e.g., routing state, IPsec data, etc.) continues to be received from one or more branches 102a, 102b, . . . 102n and sent to an SPN 110n. This is facilitated through the use of a high-availability asynchronous role election mechanism. In some embodiments, networking routing configuration data is constantly shared between NPN—primary 106 and NPN—secondary 108, such that when an NPN fails, the necessary data to restart a BGP session is known. This is enabled by state sync communication 112.

In some embodiments, the transition between FIG. 1A to FIG. 1B is facilitated through a high-availability asynchronous role election and distributed locks mechanism.

In some embodiments, where NPN—primary 106 and NPN—secondary 108 represent zones, zonal failure in NPN—primary 106 will also result in a transition from FIG. 1A to FIG. 1B.

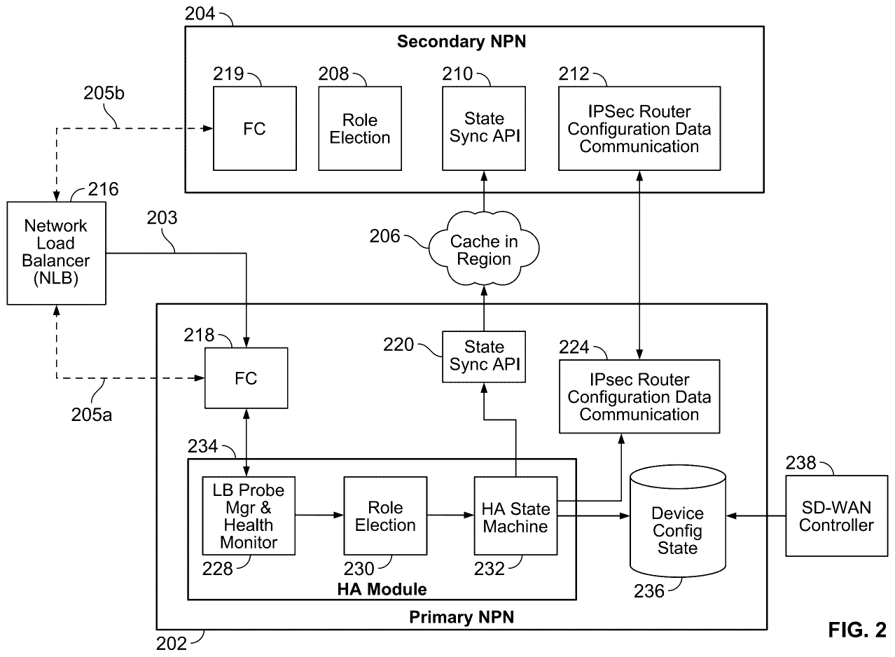

FIG. 2 is a system diagram of a CSS cluster in accordance with some embodiments. Primary NPN 202 and secondary NPN 204 are two NPNs on a CSS cluster. The two NPNs may interface with an NLB 216 that is part of the same CSS cluster. In some embodiments, the NPNs interface with cache in region 206 in order to subscribe and publish high availability (HA) states. In some embodiments, cache in region 206 comprises a lock-acquisition data storage.

Cache in region 206 may be a data storage in the region associated with the CSS cluster comprising primary NPN 202 and secondary NPN 204.

Although only two NPNs are shown in this example, NLB 216 may be in communication with two or more NPNs in various embodiments.

Primary NPN 202 comprises FC 218, HA module 234, state sync application program interface (API) 220, IPsec router configuration data communication 224, and device config state 236. In the example shown, primary NPN 202 currently fulfills the responsibilities of the active role. As such, primary NPN 202 holds the AL and the TL. Furthermore, because primary NPN 202 occupies the active role, it receives data communication 203 from NLB 216.

Data communication 203 comprises any data from NLB 216 that involves communication over a network. For example, one or more branches may send NLB 216 network packets that are being sent to an SPN. Data communication 203 comprises these network packets. In some embodiments, data communication 203 is received by FC 218. FC 218 is a component that facilitates the communication with an NLB. In some embodiments, data communication 203 comprises network traffic.

FC 218 facilitates communication between primary NPN 202 and NLB 216. FC 218 may receive data communications 203 when primary NPN 202 is able to receive network traffic (e.g., it is healthy enough to receive network traffic, it is in the active role, it holds the TL, etc.). In some embodiments, FC 218 facilitates the communication of network routing configuration data such as IPSec related data

In some embodiments, NLB 216 sends health checks 205a and 205b to primary NPN 202 and secondary NPN 204. In some embodiments, NLB 216 sends health checks to a plurality of NLBs on a CSS cluster.

Health checks 205a and 205b may contain any data which queries the health of the NPN. The health of the system may comprise of a self-assessment executed by the NPN. In some embodiments, HA module 234 facilitates a self-assessment of primary NPN 202. In some embodiments, HA module 234 forwards a health probe/check response to health FC 218, which forwards the response to NLB 216.

In some embodiments, the health probe/check responses comprise information pertaining to the ability of primary NPN 202 to fulfill the responsibilities of the active role. In some embodiments, the health probe/check responses comprise information pertaining to the ability of primary NPN 202 to send and receive traffic. Thus, NLB 216 may decide whether primary NPN 202 is able to receive traffic (e.g., data communication 203) based on one or more responses to one or more health probes. Health probes/checks/responses are described in more detail below.

In some embodiments, load balancer (LB) probe manager (mgr) & health monitor 228 facilitates the self-assessment of the primary NPN 202. For example, LB probe mgr & health monitor 228 may determine if primary NPN 202 is able to send and receive traffic at a given time. LB probe mgr & health monitor 228 may also determine if primary NPN 202 is able to fulfill the responsibilities of the active role at any given time.

LB probe mgr & health monitor 228 may be primarily responsible for responding to health probes configured on ELBs based on overall system health and status of critical services such as data path, vpnd, element manager, rtr-mgr, etc.

In some embodiments, LB probe mgr & health monitor 228 is responsible for probes to be plumbed through FC to exercise the actual data path. In some embodiments, LB probe mgr & health monitor 228 is responsible for probe enabled/disabled configuration from SD-WAN controller 238 to be used during software upgrades and vertical scaling.

In some embodiments, role election 230 facilitates role election based on the traffic trigger from NLB 216 and whether the NPN node is primary or secondary.

In some embodiments, HA state machine 232 is responsible for consuming events from become active/standby events from role election 230 and LB probe mgr & health monitor 228. In some embodiments, HA state machine 232 maintains a redundancy finite state machine.

In some embodiments, state sync API 220 publishes the session state to cache in region 206 when the role of primary NPN 202 is active. State sync API 220 may subscribe to session state when primary NPN 202 is in a standby role. In some embodiments, state sync API 220 keeps modules such as rtr-mgr updated. In some embodiments, state sync API 220 is responsible for auditing and purging cache in region 206 in case of role changes.

In some embodiments, IPsec router configuration data communication 224 facilitates the communication of state syncing data, NAT data, and other network routing configuration data between primary NPN 202 and secondary NPN 204. IPsec router configuration data communication 224 may utilize modules such as strongswan and conntrackd to facilitate communications with an external NPN. In some embodiments, communications between NPNs are facilitated by IPsec tunnels, eBGP connections, iBGP connections, or any other appropriate secure communication protocol.

In some embodiments, device config state 236 holds data associated with the overall condition of primary NPN 202 within a broader CSS. For example, if device config state 236 may hold data concerning whether primary NPN 202 is the primary NPN in a CSS or if it is the secondary NPN.

In some embodiments, SD-WAN controller 238 is an external interface that is in communication with device config state 236. SD-WAN controller 238 may be used to configure primary NPN 202 as the primary NPN or the secondary NPN within a broader CSS. SD-WAN controller 238 may be connected to one or more NPNs and be used to coordinate the one or more NPNs within a CSS cluster. For example, upon booting a CSS cluster a CSS administrator can configure one or more NPNs to boot as primary or secondary NPNs through SD-WAN controller 238. In another example, SD-WAN controller 238 may be used to configure primary NPN 202 to be able to accept health probes and respond to health probes.

In some embodiments, SD-WAN controller 238 initializes a high-availability asynchronous role election and distributed locks mechanism by sending critical network routing configuration data (e.g., IPSec keys) to primary NPN 202. This critical network routing configuration data may then be communicated to another NPN through IPsec router configuration data communication 224. Thus, when a role-election takes place, each NPN keeps the critical network routing configuration data available to be able to rapidly begin fulfilling the responsibilities of the active role.

In some embodiments, SD-WAN controller 238 sends network routing configuration data to other components within a CSS cluster, such as one or more SPNs. For example, to facilitate IPSec tunnels between an NPN and an SPN, both components may require related or the same encryption keys/authentication keys. SD-WAN controller 238 may be configured to facilitate any communication necessary for the routing of network traffic through a CSS cluster.

In some embodiments, SD-WAN controller 238 communicates with NLB 216 in order to initialize the CSS cluster comprising primary NPN 202 and secondary NPN 204. For example, SD-WAN controller 238 may communicate which NPNs of a plurality of NPNs will begin with the primary role on boot.

Secondary NPN 204 comprises flow controller (FC) 219, role election (208), state sync application program interface (API) 210, and IPSec router configuration data communication 212. In some embodiments, secondary NPN 204 is in standby mode. In the example shown, secondary NPN 204 is in standby mode, thus it is not receiving data communication 203. Because secondary NPN 204 is in standby mode in the example shown, it currently does not the hold the AL nor the TL. However, secondary NPN 204 is configured such that it is able to participate in a high-availability asynchronous role election and distributed locks mechanism at any given time.

In some embodiments, secondary NPN 204 comprises all the same components of primary NPN 202 (e.g., secondary NPN 204 may include an HA module and a device config state).

In some embodiments, cache in region 206 maintains a lock-acquisition data storage, such that the transfer of the AL and TL between primary NPN 202 and secondary NPN 204 is facilitated. In some embodiments, the state of the AL and the TL is maintained on a lock-acquisition data storage. The lock-acquisition data storage comprises lock-acquisition entries which indicate when an NPN has acquired or released a lock, as described below. Peer NPNs can determine whether a lock can be acquired by querying the lock-acquisition data storage.

In some embodiments, cache in region 206 stores data associated with the AL and TL at any given time. For example, cache in region 206 may comprise data that uniquely identifies the resource being locked. Cache in region 206 may comprise information about the NPN that holds the lock (e.g., an identifier for the NPN) and the lock's expiration time. Cache in region 206 may comprise any data allowing for efficient retrieval and management of the AL and TL across multiple NPNs in the CSS cluster.

Cache in region 206 may also store data relating to network routing configuration data (e.g., IPsec information, NAT associated information, etc.).

Cache in region 206 is configured to facilitate any inter-NPN communications necessary for high-availability asynchronous role election and distributed locks mechanism in a CSS cluster.

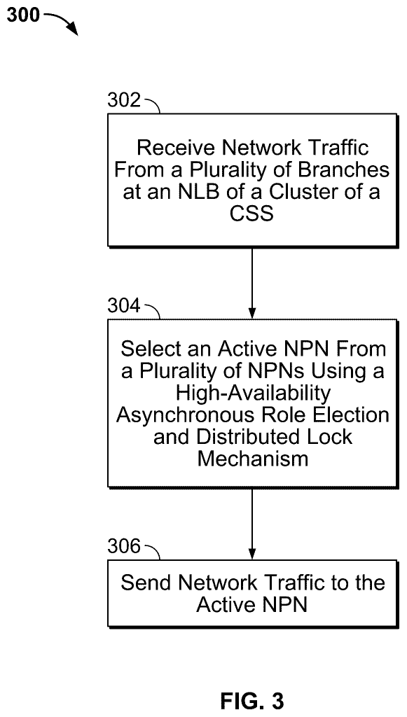

FIG. 3 is a process diagram of a process to route network traffic in accordance with some embodiments. In some embodiments, process 300 is executed by an NLB. In some embodiments, the NLB is an NLB for a cluster of a CSS. The cluster also comprises a plurality of NPNs.

At 302, an NLB executing process 302 receives network traffic from a plurality of branches. The NLB may receive network traffic from a plurality of branches.

At 304, an NLB selects an active NPN from a plurality of NPNs using a high-availability asynchronous role election and distributed locks mechanism. The NLB is configured to send network traffic to an active NPN over a standby NPN if both are healthy. However, the state of NPNs may change such that the active NPN becomes unhealthy or crashes. When the state of the NPNs changes, a high-availability asynchronous role election and distributed locks mechanism is used to determine/select an active NPN.

The high-availability asynchronous role election and distributed locks mechanism may be implemented by one or more processes/subprocesses. The one or more processes/subprocesses may be executed on one or more components of the CSS cluster (e.g., one or more NPNs).

At 306, network traffic is sent to the active NPN.

Process 300 may be repeatedly executed on a CSS cluster as the CSS cluster is on/running.

### Distributed Locks

In some embodiments, the distributed locks are implemented using a data storage (e.g., a file, a database, a cache, etc.) that is accessible by one or more NPNs on a CSS cluster. When an NPN acquires/releases a lock (AL and/or TL), it updates the data storage with data indicating an identifier (ID) of the NPN (e.g., the name of the NPN), the timestamp, and the lock that the NPN has acquired/released at that timestamp. In some embodiments, metadata is updated with the identifier (ID) of the NPN (e.g., the name of the NPN), the timestamp, and the lock that the NPN has acquired/released at that timestamp.

A second NPN may query the data storage to determine the state of the distributed locks (e.g., which locks are available or not available). In some embodiments, the timestamp is used in conjunction with the current time to determine the state of the distributed locks. For example, if there is data indicating the TL was acquired at 2023 Aug. 2 17:01:12.124698792 40000 UTC m942102.63, it is currently 2023 Aug. 2 18:01:12.124698792 40000 UTC m942102.63, and there is no other entry, then the second NPN knows that the TL is not available.

### Health Checks

In some embodiments, a device (e.g., an NLB) that is an intermediate between the original sources of network traffic (e.g., branches) and one or more NPNs periodically engages in health checks with each NPN. The device may receive responses to the health checks and determine which NPN to send traffic to based on the responses to the health checks. When the device determines that an NPN is unhealthy, it may begin to send traffic to an NPN that is healthy. In some embodiments, when the device does not receive the response, it determines that the NPN which failed to send the response is unhealthy.

### Lock-Acquisition Data Storage

In some embodiments, the state of the AL and the TL is maintained on a lock-acquisition data storage. The lock-acquisition data storage comprises lock-acquisition entries which indicate when an NPN has acquired or released a lock, as described below. Peer NPNs can determine whether a lock can be acquired by querying the lock-acquisition data storage.

### Traffic Lock

In some embodiments, an NPN that is currently receiving traffic is configured to continuously release and attempt to acquire the TL. In some embodiments, the NPN that is not receiving traffic only attempts to acquire the TL when it begins receiving traffic.

As an illustration, suppose NPN 1 is receiving traffic. While it is receiving traffic it constantly updates a data storage with lock-acquisition entries indicating NPN 1, Released TL, TIMESTAMP; NPN 1, Acquired TL, TIMESTAMP4INTERVAL; NPN 1, Released TL, TIMESTAMP42×INTERVAL; . . . . NPN 1, Acquired TL, TIMESTAMP4n×INTERVAL. The entries will be entered each INTERVAL (e.g., 1 second, 2 seconds, 1 ms, 2 ms, etc.).

Each time NPN 1 releases the TL NPN 1 acquires the TL again if NPN 1 is still receiving traffic. Now, suppose NPN 1 stops receiving traffic. The final lock-acquisition entry (i.e., the lock-acquisition entries with the most recent timestamp) will be NPN 1 Releases TL . . . , because NPNs are configured to release the TL every interval and acquire the TL on the next interval only if it is receiving traffic. Now, upon querying the data storage, NPN 2 (a peer NPN to NPN 1) knows that the TL is available. If NPN 2 begins receiving traffic it will acquire the TL and make a lock-acquisition entry to the database, starting with NPN 1, Acquired TL, TIMESTAMP4n×INTERVAL.

Suppose NPN 1 fails completely (e.g., goes completely offline such that it cannot send or receive any data), and its last lock-acquisition entry indicates that the NPN 1 has acquired the TL. In this case, the data storage may automatically create a lock-acquisition entry indicating that NPN 1 released the TL. This is because the data storage knows the interval that NPN 1 is configured to release and acquire the TL on, thus, if it does not see activity from NPN 1 within that interval, it knows that NPN is down. Therefore, if the last lock-acquisition entry by NPN 1 is NPN 1 Acquired TL, the interval passes and if there is no lock-acquisition entry for NPN 1 Released TL, data storage will know that NPN 1 has failed and indicates that the TL is released by making Release lock-acquisition entry. This allows NPN 2 to acquire the TL.

### Active Lock

In some embodiments, an NPN that is currently healthy is considered healthy because it is able to execute certain processes. A healthy NPN may hold the active lock (AL). An NPN which holds the AL may have forwarded a lock-acquisition entry to a data storage indicating that it holds the AL at a certain timestamp. The CSS cluster may be configured such that the AL has a Time-To-Live (TTL) period. When the TTL period expires, the NPN holding the AL loses the AL. In some embodiments, when an NPN that has lost the AL due to the expiration of the TTL is healthy, the AL will renew for the NPN. When the AL is renewed, the NPNs role may remain active and it may continue to advertise that it is active.

The NPN which holds the AL is granted exclusive access to secure information within the CSS cluster (e.g., peer NPNs without the AL are not able to access the information). For example, the NPN that holds the AL may have exclusive access secure information necessary for executing IPsec protocol.

### Roles

NPNs may be configured to continuously advertise their current role to other components within the CSS cluster. In some embodiments, there are two roles, active and standby. When an NPN advertises it is in the active role, other components in the CSS cluster interact with the NPN with the understanding that it performs certain functions, e.g., SPNs will establish a BGP session with the NPN, other components will query the active NPN for NAT information, IPsec tunnels are created to the NPN, etc. These function may be included in the responsibilities of the active role. An NPN in the active role is able to fulfill the responsibilities of the active role.

In some embodiments, when an NPN holds the active lock, the NPN advertises that it occupies the active role. In some embodiments, when an NPN does not hold the AL, it currently occupies a standby role. As such, when an NPN loses the AL, it may switch its role from active to standby and may immediately begin to advertise its current role. Further, when an NPN acquires the AL, it switches from an active role to a standby role and begins advertising that it occupies the standby role.

In some embodiments, the role of NPN is implied given the role of a peer NPN. For example, suppose an NPN that holds the AL and is advertising that its role is active completely crashes. After crashing, the crashed NPN will not be able to renew the AL when the AL TTL expires. The NPN that has crashed will stop receiving traffic because it will fail its health check, thus a peer NPN will begin receiving traffic. Now that the NPN is receiving traffic, it will attempt to acquire the TL. If successful, and its role is standby, it will then acquire the AL and switch its role to active. Now, the peer NPN will begin to advertise that it occupies the active role, and this will imply that the crashed NPN is in the standby role (assuming it comes back online). Thus, even though the crashed NPN never explicitly advertised that it has changed its role, the role change is implied, by the fact that the peer NPN advertises it is in the active role.

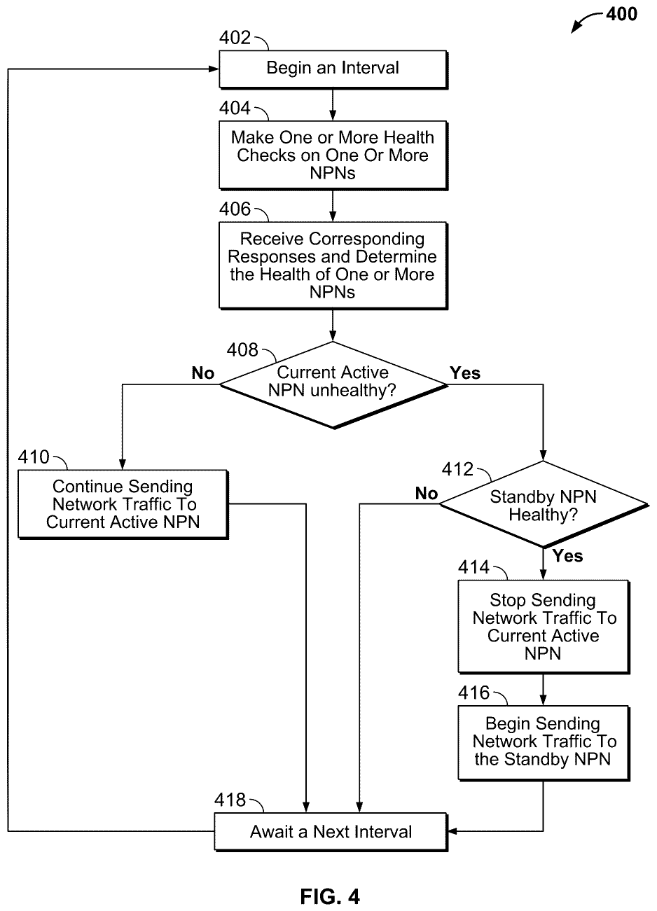

FIG. 4 is a process diagram of a process for determining an NPN to send network traffic to in accordance with some embodiments. An NPN may be any device that can send and receive network traffic. Process 400 may recur at an interval. An interval may be defined by any period of time (e.g., 1 sec, 2 sec, 1 ms, 2 ms, etc.).

At 402, an interval begins.

At 404, one or more health checks on one or more NPNs are made. In some embodiments, the NLB is configured to make health checks by sending health probes to a designated port on each of the NPNs. The NPNs are configured to listen and respond to health checks on the designated port.

Health probes may be communicated using HTTP. An example configuration of a health probe is shown below:
Path: /lb/get-health
Protocol: HTTP
Port: 8080
Interval: 1 second
Timeout: 1 second
Healthy threshold: 10 consecutive successes
Unhealthy threshold: 5 consecutive failures

In this example, the Path indicates the path on the NPN which can be accessed to return health parameters associated with the NPN. Examples of health parameters include information indicating whether Datapath/flow controller (FC) and/or other critical processes are up and running, whether connectivity with SPNs is present, whether an iBGP session is active, etc. The Port indicates the port that NPNs are configured to listen and respond on. The Interval indicates how often the health probe will be sent. The Timeout indicates the time the device will wait for a health probe response before determining that the health check has failed. The Healthy threshold indicates how many consecutive successful responses must occur for the device to determine that the NPN is healthy. The Unhealthy threshold indicates how many consecutive failures must occur for the device to determine that the NPN is unhealthy.

The FC may be an implementation of a data plane development kit (dpdk) based datapath component within the NPN.

These parameters may be modified in any way to optimally configure the health check system. For example, the Healthy threshold may be decreased to 6, which would have the effect of making the system more sensitive to a potentially unhealthy NPN.

At 406, the NLB receives the corresponding responses and determines the health of one or more NPNs. In some embodiments, a response comprises information based on a self-assessment of the NPNs' own health. The self-assessment may include assessments on the data paths, connectivity to other devices (e.g., SPNs), ability to establish BGP sessions, the ability to perform critical processes, etc. The health check response may include any information determined by a self-assessment. The self-assessment may include any assessment of functionality of the NPN. Based on the health check response, the NLB determines the health of an NPN.

In some embodiments, when an NPN executes a self-assessment and determines it is healthy, it forwards a 200 OK response. In some embodiments, when an NPN executes a self-assessment and determines it is unhealthy, it forwards a 400 Bad Request response. A successful health check response may comprise a 200 OK response, while an unsuccessful health check response may comprise a 400 Bad Request Response.

In some embodiments, the NLB measures the health of an NPN based on the NPN's current capabilities relating to occupying an active role and receiving and sending network traffic.

In some embodiments, the NLB measures the health of the NPN based on whether or not it receives a response. For example, if it does not receive a response from a particular NPN, it may determine that the NPN has completely crashed (i.e., it cannot send or receive any data).

At 408, whether the current active NPN is unhealthy is determined. When a CSS cluster boots, the NLB may determine whether one or more NPNs are healthy. In some embodiments, the primary NPN is preferred over other NPNs, such that when all things are equal, the NLB attempts to initially send network traffic to the primary NPN, thus making it the active NPN.

After booting, and during an interval, the NLB may be sending traffic to the NPN that was determined to be active at the previous interval. The NPN receiving traffic is the current active NPN. The NLB will know when the current active NPN becomes unhealthy through the health checks. In response to a determination that the active NPN is not unhealthy (e.g., the active NPN is healthy), process 400 proceeds to 410. In response to a determination that the current active NPN is unhealthy, process 400 proceeds to 412.

At 412, the health of the current standby NPN is determined. It is determined based on the health checks. The NLB sends health checks to one or more NPNs, therefore, it knows whether a standby NPN is healthy. The NLB may also know which standby NPN of one or more standby NPNs is healthy. In response to a determination that a standby NPN is unhealthy, process 400 proceeds to 418 and awaits the next interval. In response to a determination that a standby NPN is healthy, process 400 proceeds to 414.

At 414, the NLB stops sending traffic to the current active NPN. This is because through the health checks, the NLB has determined that the current active NPN is unhealthy (e.g., it cannot perform the duties of the active role).

At 416, the NLB begins sending network traffic to a healthy standby NPN. In some embodiments, there may be one or more NPNs that are peers to the active NPN. The NLB may be configured to arbitrarily choose a standby NPN that is currently healthy and begin sending traffic to it.

Referring back to 408, in response to a determination that the active NPN is not unhealthy (e.g., the active NPN is healthy), process 400 proceeds to 410.

At 410, the NLB continues to send network traffic to the active lock. The health checks have indicated that the active lock is capable of performing the duties of the active role and the basic duties of sending and receiving traffic.

At 418, the NLB awaits the next interval.

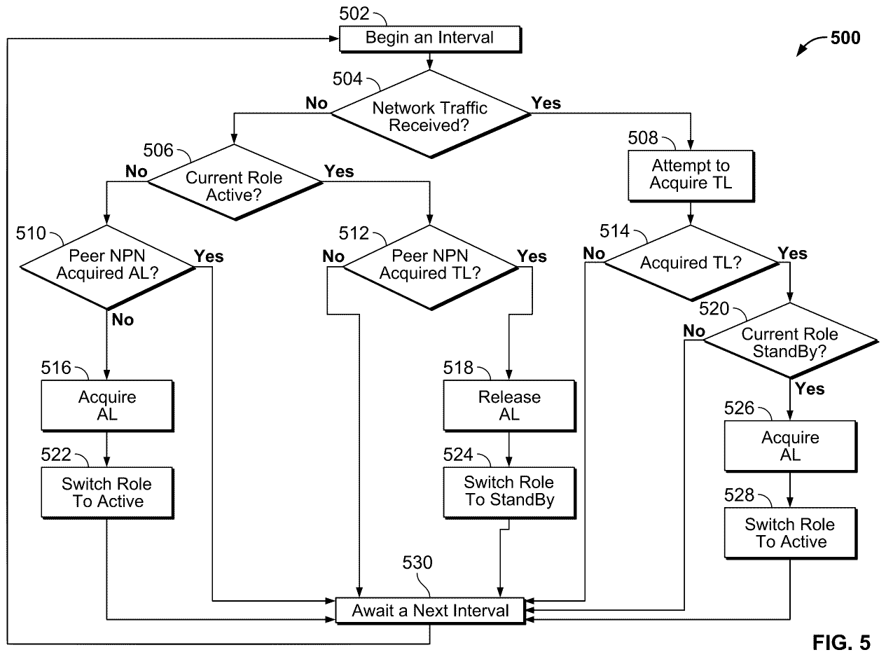

FIG. 5 is a process diagram of a process that an NPN executes on an interval in accordance with some embodiments. An NPN may be any device that can send and receive network traffic. In some embodiments, a CSS cluster is configured such that each NPN on the CSS cluster concurrently executes process 500. Process 500 may recur at an interval. An interval may be defined by any period of time (e.g., 1 ms, 2 ms, 1 sec, 2 sec, etc.). At 502, an interval begins. At 530, the NPN awaits the next interval.

At 504, whether network traffic is received is determined. In some embodiments, an NLB sends network traffic to an NPN. In some embodiments, an NPN awaits traffic from the NLB. In some embodiments, the CSS cluster has recently booted, and network traffic will begin arriving to the CSS cluster shortly after booting. When network traffic arrives at the CSS cluster, it will first arrive at an NLB. The NLB will send the traffic to an active NPN.

In response to a determination that the NPN is receiving network traffic, process 500 proceeds to 508. In response to a determination that the NPN is not receiving network traffic, process 500 proceeds to 506.

At 508, the NPN attempts to acquire the traffic lock (TL). In some embodiments, the NPN retrieves the TL from a database comprising the TL and the AL. In some embodiments, the NPN is unable to receive the TL because another device (e.g., a peer NPN) currently holds the traffic lock.

In some embodiments, the NPN attempts to acquire the TL by checking a data storage with lock-acquisition information. The success of the attempt to acquire the TL will be determined by the last TL lock-acquisition entry. For example, if the last lock-acquisition entry for the TL indicates the TL has been released, the NPN will be able to acquire the TL.

At 514, it is determined whether the TL is acquired. In response to a determination that the TL is not acquired, process 500 proceeds to 530, and the NPN awaits the next interval. In response to a determination that the TL has been acquired, process 500 proceeds to 520.

An NPN may reach 514 when a second NPN which holds the TL may not have yet released the TL but will release the TL in the next interval. Thus, after the next interval begins, an NPN will be able to acquire the TL at 514.

At 520, the current role of the NPN is determined. In some embodiments, the NPN can occupy one of two roles at any given time, standby or active. In the standby role, the NPN remains ready to switch to the active role at any given time.

In response to a determination that the current role is not standby (e.g., the current role is active), process 500 proceeds to 530. This may occur when the NPN is receiving traffic and was already active at the beginning of the interval. In response to the determination that the current role is standby, process 500 proceeds to 526.

At 526, the NPN acquires the active lock. In some embodiments, after the NPN determines that it is receiving traffic and it has received the TL, it knows that it is now the active instance. Therefore, it is able to acquire the AL. The AL allows the NPN to fulfill the responsibilities of the active role. The responsibilities of the active role comprise establishing connections which facilitate the transfer of network routing configuration data (e.g., IPsec information, NAT associated information, etc.). In some embodiments, upon acquiring the AL, the NPN is able to access IPSec secrets.

In some embodiments, the NPN is able to acquire the AL because another device has released the AL. The AL may be released when the NPN fails to renew the AL. In some embodiments, the CSS cluster applies a time to live (TTL) scheme to the AL. The TTL scheme of the active lock causes the AL to automatically renew as long as the NPN is healthy. When the NPN becomes unhealthy, the AL is not renewed, and a different NPN is able to acquire the AL.

In some embodiments, when the NPN acquires the AL, it sends a lock-acquisition entry to a lock-acquisition data storage. This lock-acquisition data storage entry may indicate to peer NPNs that the AL is unavailable.

At 528, the NPN executing process switches its role to active. When the NPN's role becomes active it may immediately advertise to other components of the CSS cluster that it is the active NPN. In some embodiments, it immediately begins executing certain processes/performing certain functionality, that is only executed/performed by a single active NPN. After 528, the NPN executing the process proceeds to 530 and awaits the next interval.

Referring back to 504, in response to a determination that network traffic is not being received, process 500 proceeds to 506.

At 506, it is determined whether the current role is active. The current role may be active because the AL TTL has not expired yet, therefore, even when the NPN executing the process is not receiving traffic, its current role may be active. In some embodiments, the current role is active, but there is no traffic being received because there is no traffic being sent to the device (e.g., an NLB) that sends traffic to devices executing process 500.

In response to a determination that the current role is not active, process 500 proceeds to 510. In response to a determination that the current role is active, process 500 proceeds to 512.

At 510, it is determined whether a peer NPN has acquired the active lock. In some embodiments, this is determined by querying a data storage which contains lock-acquisition entries. In response to a determination that a peer has not acquired the AL, process 500 proceeds to 516. In response to a determination that a peer has acquired the AL process, 500 proceeds to 530.

At 516, the active lock is acquired. The NPN may acquire the AL at 516 because no traffic is being sent to a peer device as well. To acquire the AL, the NPN may make a lock-acquisition entry to a lock-acquisition data storage indication that it has acquired the AL.

At 522, the role of the NPN is switched to active. When the NPN's role becomes active it may immediately advertise to other components of the CSS cluster that it is the active NPN. In some embodiments, advertising to other components of the CSS cluster comprises updating an SD-WAN/SD-WAN controller that the HA state of the NPN is active.

Referring back to 506, In response to a determination that the current role is active, process 500 proceeds to 512.

At 512, it is determined whether a peer NPN has acquired the traffic lock. In some embodiments, when a device determines that a peer has acquired the TL, this indicates to the NPN that a role re-election should occur. A device may reach 512 because it was healthy enough to be active at an earlier time but has since failed a health check and is not receiving traffic. Thus, even if the NPN has not completely crashed, the NPN may still lack the health to fulfill the responsibilities of the active role. The NPN may determine whether a peer device has acquired the TL by querying a lock-acquisition data storage.

In response to a determination that a peer device has not acquired the TL, the NPN proceeds to 530. In response to a determination that a peer device has acquired the traffic lock, the NPN proceeds to 518.

At 518, the active lock is released. The NPN may release the AL by making a lock-acquisition entry to a data storage indicating that it has released the AL. The NPN may release the AL by allowing the TTL of the AL to expire and failing to renew the AL. The lock-acquisition data storage may determine that the NPN has released the AL when the NPN does not renew the AL after the TTL.

At 524, the NPN switches its role to standby. In some embodiments, the NPN begins advertising to other devices within a CSS cluster that it is the standby device.

At 530, the NPN awaits the next interval.

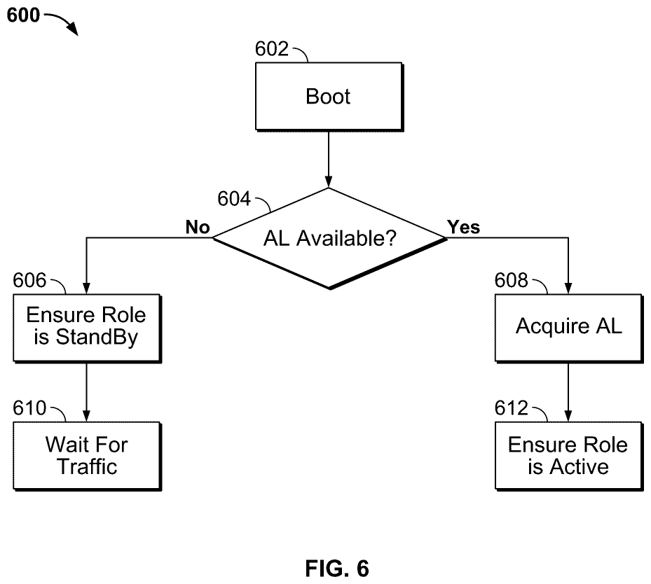

FIG. 6 is a process diagram of a process that an NPN executes upon booting up in accordance with some embodiments. An NPN may be any device that can send or receive traffic.

At 602, the NPN boots. In some embodiments, an NPN boots as an overall system boots (e.g., as an entire CSS boots). In some embodiments, where the NPN is booting with an overall system, a primary NPN is given priority to the AL over one or more secondary NPNs, such that if both are healthy, the primary NPN is able to acquire the AL first.

In some embodiments, an NPN boots after crashing. For example, if the overall system is running and an NPN crashes, it may be rebooted. Upon rebooting, it executes process 600.

At 604, it is determined whether the active lock (AL) is available. This determination may be made by querying a data storage. In response to a determination that the AL is available, the NPN proceeds to 608. In response to a determination that the AL is not available, the NPN proceeds to 606.

At 606, the NPN ensures that its role is standby. In some embodiments, upon booting, the NPN is the secondary NPN and therefore its default role is standby. In some embodiments, the NPN occupied the active role but has since crashed. Therefore, when it realizes that the AL is taken, it knows that it must now occupy the standby role. Thus, it changes its role to standby.

One aspect of occupying a role is advertising to other components in an overall system that the NPN occupies the role. For example, when an NPN occupies the standby role, it advertises other components in a CSS cluster that it occupies the standby role.

Assuming the NPN boots and is healthy, the NPN, now in a standby role, will respond to health checks confirming that it is ready to occupy the active role. If the NPN boots and determines it is not healthy, then the NLB will still be able to determine that it is unhealthy and cannot occupy the active role. Thus, the NLB will not attempt to forward traffic to this NPN.

In some embodiments, when the primary NPN boots unhealthy, the NPN does not acquire the AL, because the NLB senses that the NPN is unhealthy. Thus, the NLB will forward traffic to a secondary NPN.

At 610, the NPN waits for traffic. As the standby NPN, the NPN waits for traffic in the event that the active NPN fails. When the standby NPN receives traffic from the NLB, a role election facilitated by a high-availability asynchronous role election and distributed lock mechanism commences.

Referring back to 604, in response to a determination that the AL is available, the NPN proceeds to 608.

At 608, the NPN acquires the AL. In some embodiments, the NPN acquires the AL by indicating to a data storage that it has acquired the AL.

At 612, the NPN ensures its role is active. If the role was already active (e.g., it is the primary NPN, it was active before boot, etc.), then the role remains active. In some embodiments, when the NPN switches its role to active it begins advertising to one or more components in the overall system that it is active. Thus, the overall system treats the NPN as the active NPN and the NPN fulfills the responsibilities of the active NPN.

In some embodiments, one or more NPNs simultaneously boot. This may occur when an entire CSS cluster boots. Both NPNs execute process 600 concurrently, one ends up with the active role and one ends up with the standby role. Both NPNs advertise to the CSS cluster their respective roles. In some embodiments, a primary NPN occupies the active role and one or more secondary NPNs occupy the standby role. This configuration allows for the high-availability role election and distributed lock mechanism to occur. Thus, a robust connection to an active NPN exists at any given time.

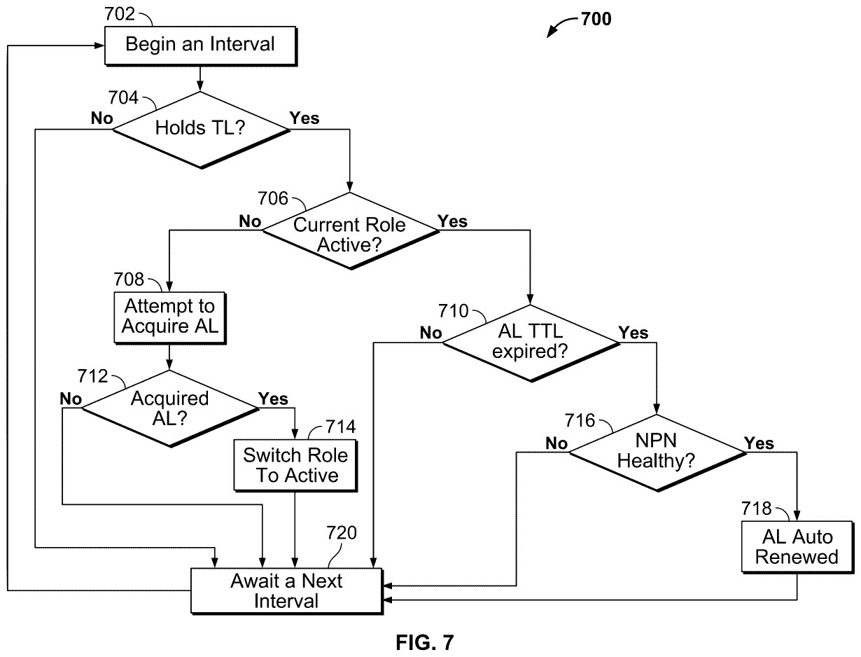

FIG. 7 is a process diagram of a process that an NPN executes on an interval in accordance with some embodiments. An NPN may be any device that can send and receive network traffic. In some embodiments, a CSS cluster is configured such that each NPN on the CSS cluster concurrently executes process 700. Process 700 may recur at an interval. An interval may be defined by any period of time (e.g., 1 ms, 2 ms, 1 sec, 2 sec, etc.). At 702, an interval begins. At 720, the NPN awaits the next interval.

At 704, it is determined whether the NPN holds the TL. The NPN may own the TL when it has acquired the TL and has not released the TL. An overall system comprising the NPN may know that the NPN holds the TL because the last lock-acquisition entry in a lock-acquisition database concerning the TL indicates that the NPN has acquired the TL.

In response to a determination that the NPN holds the TL, the NPN proceeds to 706. In response to a determination that the NPN does not own the TL, the NPN proceeds to 720.

At 706, it is determined whether the current role of the NPN is active. The NPN knows its current role. The NPN's current role may have been previously set to active when it had previously acquired the AL and set its role to active.

In response to a determination that the NPN's current role is not active, the process 700 proceeds to 708. In response to a determination that the NPN's current role is active, the process 700 proceeds to 710.

At 708, the NPN attempts to acquire the AL. In some embodiments, the attempt to acquire the AL comprises querying a lock-acquisition data storage for the most recent lock-acquisition entry pertaining to the AL. Step 708 may be reached when a peer NPN has failed a health check in a prior interval, causing traffic to be sent to the NPN. Because traffic is being sent to the NPN, it acquires the TL. Assuming the NPN continues to be healthy, it reaches 708.

At 712, it is determined whether the NPN has acquired the AL. This determination may be reached when the NPN which previously held the AL has released the AL. The AL may have been released because its previous owner has become unhealthy or crashed. In some embodiments, the NPN is unsuccessful in acquiring the AL but is still receiving traffic, because a peer NPN has not yet released the AL.

In response to a determination that the AL has been acquired, process 700 proceeds to 714. In response to a determination that the AL has not been acquired, process 700 proceeds to 720.

At 714, the NPN switches its role to active. The NPN begins advertising to the overall system that it is active and begins to fulfill the responsibilities of the active role.

At 710, it is determined whether the AL TTL has expired. In some embodiments, the AL TTL is longer than the interval. For example, the interval may be 2 sec and the TTL is 5 sec. The TTL is an interval at which the AL expires. When the TTL expires, the lock-acquisition data storage may create an entry indicating that the AL has been released. When the AL expires, the NPN holding the AL must auto renew the AL.

In response to a determination that the AL TTL has expired, process 700 proceeds to 716. In response to a determination that the AL TTL has not expired, process 700 proceeds to 720.

At 716, whether the NPN is healthy is determined. The NPN may determine whether it is healthy based on a self-assessment of health. In some embodiments, an NPN is considered healthy when it is available to fulfill the responsibilities of the active role. In response to a determination that the NPN is healthy, process 700 proceeds to 718. In response to a determination that the NPN is not healthy, process 700 proceeds to 720.

In some embodiments, 716 proceeds to 720 when the NPN has completely crashed. In this scenario, the NPN with the current role active is not able to fulfill the responsibilities of the active role, lets the AL TTL expire, and does not auto renew the AL. Therefore, even if the NPN has completely crashed, the AL is still released and a peer NPN is able to acquire the AL.

At 718, the AL is auto renewed. The AL may be auto renewed by making a lock-acquisition entry to a lock-acquisition data storage indicating that the AL has been auto renewed and the NPN continues to hold the AL. The AL may be configured such that it can only be auto renewed when the NPN holding it is able to fulfill the responsibilities of the active role.

At 720, the NPN awaits the next interval.

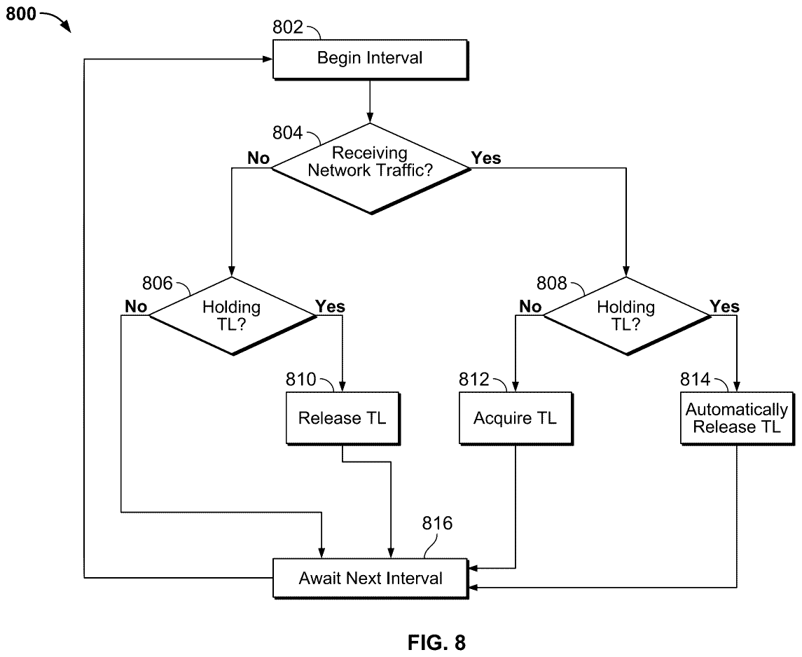

FIG. 8 is a process diagram of a process that an NPN executes on an interval in accordance with some embodiments. An NPN may be any device that can send and receive network traffic. In some embodiments, a CSS cluster is configured such that each NPN on the CSS cluster concurrently executes process 800. Process 800 may recur at an interval. An interval may be defined by any period of time (e.g., 1 ms, 2 ms, 1 sec, 2 sec, etc.). At 802, an interval begins. At 816, the NPN awaits the next interval.

At 804, it is determined whether the NPN is receiving network traffic. The NPN may be receiving network traffic from another component (e.g., an NLB) when the other component has determined that the NPN is healthy and is able to receive network traffic. In some embodiments, the NPN begins receiving network traffic when an NLB determines that a peer NPN that was receiving network traffic has become unhealthy.

In response to a determination that the NPN is receiving network traffic, process 800 proceeds to 808. In response to a determination that the NPN is not receiving network traffic, process 800 proceeds to 806.

At 806, it determined whether the NPN is holding the TL. In some embodiments, an NPN is able to determine whether it is holding the TL. For example, the NPN may comprise a configuration file which stores a Boolean that indicates whether it currently holds the TL.

In response to a determination that the NPN is not holding the TL, process 800 proceeds to 816. In response to a determination that the NPN is holding the TL, process 800 proceeds to 810.

At 810, the TL is released. In some embodiments, releasing the TL comprises making a lock-acquisition entry to a lock-acquisition database indicating that the NPN has released the TL.

At 808, it is determined whether the TL is being held. In some embodiments, an NPN is able to determine whether it is holding the TL. For example, the NPN may comprise a configuration file which stores a Boolean that indicates whether it currently holds the TL.

In response to a determination that the NPN is not holding the TL, process 800 proceeds to 812. In response to a determination that the NPN is holding the TL, process 800 proceeds to 814.

At 812, the TL is acquired. In some embodiments, acquiring the TL comprises making a lock-acquisition entry to a lock-acquisition database indicating that the NPN has acquired the TL. An NPN may be currently receiving network traffic and be continually acquiring and releasing the TL.

At 814, the TL is automatically released. The TL is automatically released by the NPN that is holding it. The TL is automatically released even when the NPN holding the TL is receiving traffic. This configuration is necessary for preemption. Furthermore, this allows for involuntary role re-election.

At 816, the NPN awaits the next interval.

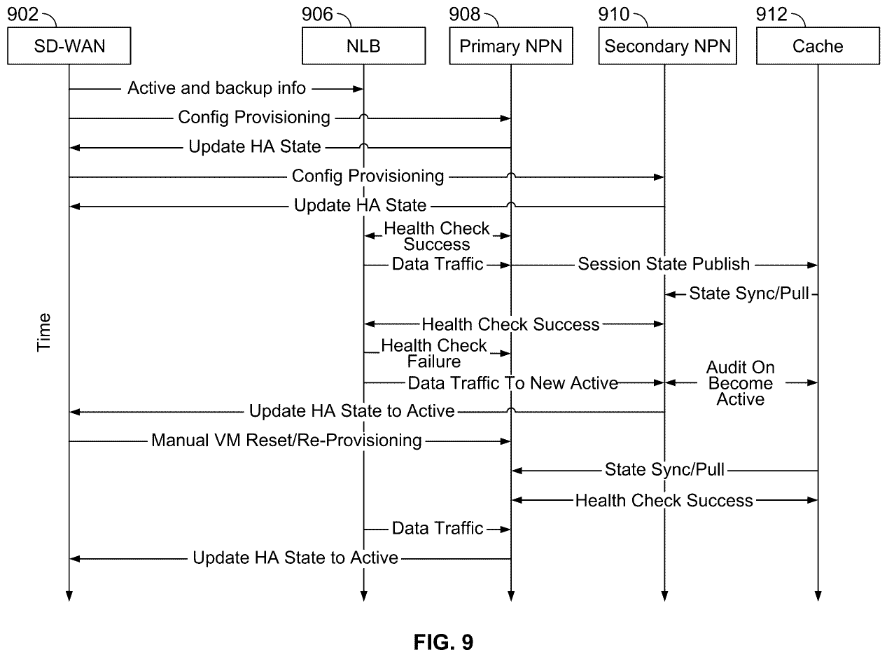

FIG. 9 is a timeline illustrating a device failure within a CSS cluster in accordance with some embodiments. In this illustration shown, the arrows pointing down indicating the forward arrow of time. However, this is for illustrative purposes, and in various embodiments, one or more actions/communications may occur simultaneously or in another order through a given time period. In this example SD-WAN 902 is configured to control a CSS cluster comprising load balancer (LB) 906, primary NPN 908, secondary NPN 910, and cache 912. The cache 912 may be a cache in the region associated with the CSS cluster.

On boot, SD-WAN 902 controller sends NLB 906 the identity of the active and backup NPN's, as illustrated by the active and backup info arrow. This is part of the initialization of a high-availability asynchronous role election and distributed locks mechanism. In some embodiments, the NPN that is identified as the primary NPN 908 will be the first NPN to receive the active lock and the first NPN to receive traffic from NLB 906. In this example, primary NPN 908 is identified as the primary NPN and will begin as the active NPN and the NPN receiving traffic.

SD-WAN 902 sends config provisioning information to primary NPN 908. This provides primary NPN 908 with the network routing configuration data required for primary NPN 908 to fulfill the responsibilities of the active role. For example, config provisioning information may comprise IPSec related data or data related to engaging in iBGP and/or eBGP sessions. In some embodiments, primary NPN 908 communicates this data with secondary NPN 910. This ensures that secondary NPN 910 is able to rapidly switch to the active role.

Primary NPN 908 updates SD-WAN 902 with its current HA state. Primary NPN 908 updates its HA state on boot such that SD-WAN 902 may configure other components in the CSS cluster (e.g., NLB 906) with the current health status of primary NPN 908. This is done to ensure that the chosen primary NPN 908 is ready to fulfill the responsibilities of the active role and/or receive traffic.

Config provisioning is sent to secondary NPN 910. The config provisioning information configures secondary NPN 910 to fulfill the role of the standby NPN. In some embodiments, as a result of this communication, secondary NPN 910 is configured to execute a process such that it is ready to receive traffic, acquire the TL, and acquire the AL when role election takes place.

Secondary NPN 910 updates SD-WAN 902 of its current HA state. Secondary NPN 910 updates its HA state on boot such that SD-WAN 902 may configure other components in the CSS cluster (e.g., NLB 906) with the current health status of secondary NPN 910. This is done to ensure that the chosen secondary NPN 910 is ready to fulfill the responsibilities of the active role and/or receive traffic.

NLB 906 then sends a health check to primary NPN 908. In this example, the health check is successful. In this example, NLB 906 will begin to send network traffic to primary NPN 908. Network traffic may comprise of data communications.

As primary NPN 908 begins seeing network traffic, it publishes its session state to cache 912. In this example, primary NPN 908 informs cache 912 that it is receiving traffic and it is currently occupying the active role. Thus, primary NPN 908 currently holds the AL and the TL. In this example, primary NPN 908 is executing one or more processes (e.g., releasing and acquiring the TL, applying the TTL to the AL, etc.) in order to facilitate a high-availability asynchronous role election and distributed locks mechanism. At this point, primary NPN 908 is the NPN that holds the active role.

As part of these processes, primary NPN 908 and cache 912 execute a state sync/pull. In this example, the state sync/pull comprises an exchange of information associated with the AL and the TL.

In this example, a successful health check occurs between secondary NPN 910 and NLB 906. This successful health check may inform NLB 906 that secondary NPN 910 is ready to start receiving traffic in the case that primary NPN 908 fails.

Primary NPN 908 exchanges a health check which results in a failure with NLB 906. This may be for a variety of reasons. In some embodiments, a failing health check occurs when an NPN is unable to even respond to a health probe. In some embodiments, a failing health check occurs when an NPN performs a self-assessment and determines that it does not possess the requisite health to fulfill the responsibilities of the active role. In some embodiments, after a self-assessment, the NPN determines that it is not able to send and receive network traffic. In various embodiments, primary NPN 908 responds to a health probe from NLB 906 indicating that it is unhealthy.

Upon receiving information that primary NPN 908 has failed a health check, NLB 906 begins sending data traffic to secondary NPN 910. NLB 906 knows that secondary NPN 910 is healthy because of previous communications. In some embodiments, upon receiving information that a currently active NPN is unhealthy, NLB 906 immediately begins sending data to a peer NPN. This ensures that there is minimal latency caused by the failure of an NPN.

When secondary NPN 910 begins receiving traffic it begins to engage in role election. Secondary NPN 910 may acquire the TL upon receiving network traffic.

Secondary NPN 910 exchanges an audit with cache 912 when it becomes active. In some embodiments, this happens immediately upon seeing traffic. The audit with cache 912 may comprise of receiving the TL and determining if the AL is available. In some embodiments, the audit with cache 912 comprises the erasure of previous unnecessary state data. In some embodiments, the audit with cache 912 comprises the exchange of necessary network routing configuration data, where the network routing configuration data is not already known by secondary NPN 910.

In some embodiments, after secondary NPN 910 successfully acquires the AL, it updates its HA state as active to SD-WAN 902. In some embodiments, SD-WAN 902 communicates the identity of the new active NPN to other components of the CSS cluster. This may allow secondary NPN 910 to fully fulfill the responsibilities of the active role because other components of the CSS cluster, such as SPNs, will begin to function such that the secondary NPN 910 is the active NPN. In some embodiments, the new active NPN begins advertising to other components comprising the CSS cluster that it is the new active NPN.

Thus, the high-availability asynchronous role election and distributed locks mechanism has successfully allowed that network traffic from NLB 906 can continue to be routed to its locations within and beyond the CSS cluster despite the failure of primary NPN 908.

In some embodiments, SD-WAN 902 facilitates a manual VM reset/re-provisioning of primary NPN 908 such that it is able to recover from the failure, which led to the prior unsuccessful health check. In some embodiments, upon this reset/reprovisioning, primary NPN 908 is once again able to receive traffic and/or fulfill the responsibilities of the active role.

In some embodiments, primary NPN 908 begins to occupy the standby role. Primary NPN 908 may advertise this role to other components of the CSS cluster, thus upon the failure of secondary NPN 910 the high-availability asynchronous role election and distributed locks mechanism can allow the transfer of the active role back to primary NPN 908.

In some embodiments, the CSS cluster is configured such that when primary NPN 908 becomes able to fulfill the responsibilities of the active role, it automatically grants primary NPN 908 the active role.

This may be facilitated by a state sync/pull communication between cache 912 and primary NPN 908. After the state sync/pull communication, cache 912 and primary NPN 908 engage in a successful health check. In some embodiments, these communications with cache 912 allow primary NPN 908 to reacquire the AL and the TL. When this occurs, NLB 906 begins sending traffic to primary NPN 908 once again.

Primary NPN 908 may update its HA state to active through a communication with SD-WAN 902. In some embodiments, primary NPN 908 begins advertising to other components within the CSS cluster that it now occupies the active role.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving network traffic from a plurality of branches at a network load balancer (NLB) of a cluster of a cloud security service (CSS), wherein the cluster includes a plurality of network processing nodes (NPNs); and
selecting an active NPN from the plurality of NPNs using a high-availability asynchronous role election and distributed locks mechanism; and
sending the network traffic from the NLB to the active NPN.

2. The method of claim 1, wherein the plurality of network processing nodes includes a first NPN and a second NPN.

3. The method of claim 1, wherein the plurality of network processing nodes includes a first NPN and a second NPN further comprising an active lock (AL) and a traffic lock (TL).

4. The method of claim 1, wherein the plurality of network processing nodes comprises a first NPN and a second NPN further comprising an active lock (AL) and a traffic lock (TL) further comprising:
performing one or more health checks on one or more NPNs;
receiving corresponding responses and determining the health of the one or more NPNs;
determining whether a current active NPN is unhealthy;
in response to a determination that the current active NPN is not unhealthy, continue sending the network traffic to the current active NPN and awaiting a next interval; and
in response to a determination that the current active NPN is unhealthy, perform the following:
determining whether a standby NPN is healthy;
in response to a determination that the standby NPN is healthy, stop sending the network traffic to the current active NPN; and
begin sending network traffic to the standby NPN; and
awaiting a next interval.

5. The method of claim 1, wherein the plurality of network processing nodes comprises a first NPN and a second NPN further comprising an active lock (AL) and a traffic lock (TL) further comprising:
determining whether the network traffic is being received;
in response to a determination that network traffic is not being received, determining whether a current role is active;
in response to a determination that the current role is not active, determining whether a peer NPN has acquired the active lock (AL);
in response to a determination that a peer NPN has not acquired the AL:
acquiring the AL;
switching role to active; and
awaiting a next interval; and
in response to a determination that a peer NPN has acquired the AL, awaiting the next interval.

6. The method of claim 1, wherein the plurality of network processing nodes comprises a first NPN and a second NPN further comprising an active lock (AL) and a traffic lock (TL) further comprising:
determining whether the network traffic is being received;
in response to a determination that the network traffic is not being received, determining whether a current role is active;
in response to a determination that the current role is active, determining whether a peer NPN has acquired the traffic lock (TL);
in response to a determination that a peer NPN has acquired the TL;
releasing the AL;
switching role to active; and
awaiting a next interval; and
in response to a determination that a peer NPN has not acquired the TL, awaiting the next interval.

7. The method of claim 1, wherein the plurality of network processing nodes comprises a first NPN and a second NPN further comprising an active lock (AL) and a traffic lock (TL) further comprising:
determining whether the network traffic is being received;
in response to a determination that network traffic is being received, attempting to acquire the TL;
in response to a determination that the TL has been acquired, determining whether a current role is standby;
in response to a determination that the current role is standby:
acquiring the AL;
switching the role to active; and
awaiting a next interval;
in response to a determination that the current role is not standby, awaiting the next interval; and
in response to a determination that the TL has not been acquired, awaiting the next interval.

8. The method of claim 1, wherein the plurality of network processing nodes comprises a first NPN and a second NPN further comprising an active lock (AL) and a traffic lock (TL) further comprising:
determining whether the AL is available after an initial bootup;
in response to a determination that the AL is not available:
ensuring role is standby; and
waiting for network traffic; and
in response to a determination that the AL is available:
acquiring the AL; and
ensuring role is active.

9. The method of claim 1, wherein the plurality of network processing nodes comprises a first NPN and a second NPN further comprising an active lock (AL) and a traffic lock (TL) further comprising:
determining whether the TL is held;
in response to a determination that the TL is not being held, awaiting a next interval;
in response to a determination that the TL is being held, determining whether a current role is active; and
in response to a determination that the current role is active:
determining whether the AL time to live (TTL) has expired;
in response to a determination that the AL TTL has expired:
determining whether the NPN is healthy;
in response to a determination that the NPN is healthy, auto renewing the AL;
in response to the determination that the NPN is healthy, awaiting the next interval; and
in response to a determination that the AL TTL has not expired, awaiting a next interval.

10. The method of claim 1, wherein the plurality of network processing nodes comprises a first NPN and a second NPN further comprising an active lock (AL) and a traffic lock (TL) further comprising:
determining whether the TL is held;
in response to a determination that the TL is not being held, awaiting a next interval;
in response to a determination that the TL is being held, determining whether a current role is active; and
in response to a determination that the current role is not active:
attempting to acquire the AL;
in response to a determination that the AL has been acquired:
switching the role to active; and
awaiting a next interval; and
in response to a determination that the AL has not been acquired, awaiting a next interval.

11. The method of claim 1, wherein the plurality of network processing nodes comprises a first NPN and a second NPN further comprising an active lock (AL) and a traffic lock (TL) further comprising:
determining whether network traffic is being received;
in response to a determination that the network traffic is being received:
determining whether the TL is held;
in response to a determination that the TL is being held:
automatically releasing the TL; and
awaiting a next interval; and
in response to a determination that the TL is not being held:
acquiring the TL; and
awaiting a next interval; and
in response to a determination that network traffic is not being received:
determining whether the TL is held;
in response to a determination that the TL is being held:
releasing the TL; and
awaiting a next interval; and
in response to a determination that the TL is not being held, awaiting a next interval.

12. A system, comprising:
a processor configured to:
receive network traffic from a plurality of branches at a network load balancer (NLB) of a cluster of a cloud security service (CSS), wherein the cluster includes a plurality of network processing nodes (NPNs);
select an active NPN from the plurality of NPNs using a high-availability asynchronous role election and distributed locks mechanism; and
send the network traffic from the NLB to the active NPN; and
a memory coupled to the processor and configured to provide the processor with instructions.

13. The system of claim 12, wherein the plurality of network processing nodes includes a first NPN and a second NPN.

14. The system of claim 12, wherein the plurality of network processing nodes includes a first NPN and a second NPN further comprising an active lock (AL) and a traffic lock (TL).

15. The system of claim 12, wherein the plurality of network processing nodes comprises a first NPN and a second NPN further comprising an active lock (AL) and a traffic lock (TL) further comprising:
perform one or more health checks on one or more NPNs;
receive corresponding responses and determining the health of the one or more NPNs;
determine whether a current active NPN is unhealthy;
in response to a determination that the current active NPN is not unhealthy, continue to send the network traffic to the current active NPN and awaiting a next interval; and
in response to a determination that the current active NPN is unhealthy, perform the following:
determine whether a standby NPN is healthy;
in response to a determination that the standby NPN is healthy, stop sending the network traffic to the current active NPN; and
begin sending network traffic to the standby NPN; and
await a next interval.

16. The system of claim 12, wherein the plurality of network processing nodes comprises a first NPN and a second NPN further comprising an active lock (AL) and a traffic lock (TL) further comprising:
determine whether the network traffic is being received;
in response to a determination that network traffic is not being received, determine whether a current role is active;
in response to a determination that the current role is not active, determining whether a peer NPN has acquired the active lock (AL);
in response to a determination that a peer NPN has not acquired the AL:
acquire the AL;
switch role to active; and
await a next interval; and
in response to a determination that a peer NPN has acquired the AL, await the next interval.

17. The system of claim 12, wherein the plurality of network processing nodes comprises a first NPN and a second NPN further comprising an active lock (AL) and a traffic lock (TL) further comprising:
determine whether the network traffic is being received;
in response to a determination that the network traffic is not being received, determine whether a current role is active;
in response to a determination that the current role is active, determine whether a peer NPN has acquired the traffic lock (TL);
in response to a determination that a peer NPN has acquired the TL;
release the AL;
switch role to active; and
await a next interval; and
in response to a determination that a peer NPN has not acquired the TL, await the next interval.

18. The system of claim 12, wherein the plurality of network processing nodes comprises a first NPN and a second NPN further comprising an active lock (AL) and a traffic lock (TL) further comprising:
determine whether the network traffic is being received;
in response to a determination that network traffic is being received, attempt to acquire the TL;
in response to a determination that the TL has been acquired, determine whether a current role is standby;
in response to a determination that the current role is standby:
acquire the AL;
switch the role to active; and
await a next interval;
in response to a determination that the current role is not standby, await the next interval; and
in response to a determination that the TL has not been acquired, await the next interval.

19. The system of claim 12, wherein the plurality of network processing nodes comprises a first NPN and a second NPN further comprising an active lock (AL) and a traffic lock (TL) further comprising:
determine whether the AL is available after an initial bootup;
in response to a determination that the AL is not available:
ensure role is standby; and
wait for network traffic; and
in response to a determination that the AL is available:
acquire the AL; and
ensure role is active.

20. A computer program product embodied in a non-transitory computer readable medium and comprising computer instructions for:
receiving network traffic from a plurality of branches at a network load balancer (NLB) of a cluster of a cloud security service (CSS), wherein the cluster includes a plurality of network processing nodes (NPNs); and
selecting an active NPN from the plurality of NPNs using a high-availability asynchronous role election and distributed locks mechanism; and
sending the network traffic from the NLB to the active NPN.
